(19) United States
(12) Patent Application Publication
(10) Pub. No.: US 2003/0078928 A1
(43) Pub. Date: Apr. 24, 2003

(54) Network wide ad targeting

(76) Inventors: Alden Dorosario, Acton, MA (US); Douglas H. Beeferman, Waltham, MA (US)

Correspondence Address: FISH & RICHARDSON PC, 225 FRANKLIN ST, BOSTON, MA, 02110, US

(21) Appl. No.: 10/002,470

(22) Filed: Oct. 23, 2001

(51) Int. Cl. G06F 17/30

(52) U.S. Cl. 707/10

(57) ABSTRACT

An advertisement targeting process for determining the advertisement preferences of a user includes a query monitoring process for monitoring the queries entered by users. A query association process associates each monitored query with one or more predefined advertisement categories. A preference file maintenance process maintains, for each user, an advertisement preference file that specifies the predefined advertisement categories associated with each monitored query entered by the user. This generates a list of user-preferred advertisement categories.

### TECHNICAL FIELD

This invention relates to advertisement targeting, and more particularly to Internet-based advertisement targeting.

### BACKGROUND

The Internet is a phenomenal tool in that it allows millions of users to access millions of pages of data. Everyday, the uses of the Internet are constantly expanding, with a large percentage of these increases being in the area of Internet electronic commerce (i.e., e-commerce). Currently a multi-billion dollar market, traditional “bricks-n-mortar” companies are struggling to add an e-commerce component to their business plans.

Unfortunately, due to the vastness of the Internet, users can often be intimidated, as the number of choices for web sites and the number of products available to the user can be daunting.

In addition to traditional print ads, web sites advertise through the use of banner ads, which are linked to that website's homepage or a specific product available on that website. Typically, these banner ads are targeted to a specific consumer demographic. Unfortunately, these demographic groups are often too broad to accurately portray the specific likes and dislikes of the specific consumer visiting a web site.

### SUMMARY

According to an aspect of this invention, an advertisement targeting process for determining the advertisement preferences of a user includes a query monitoring process for monitoring the queries entered by a user. A query association process associates each monitored query with one or more predefined advertisement categories. A preference file maintenance process maintains, for each user, an advertisement preference file that specifies the predefined advertisement categories associated with each monitored query entered by the user. This generates a list of user-preferred advertisement categories.

One or more of the following features may also be included. The preference file maintenance process includes a status determination process for determining if an advertisement preference file exists for the user. The preference file maintenance process includes a preference file creation process, responsive to the status determination process, for creating the advertisement preference file for the user if it is determined that an advertisement preference file does not exist for that user. The preference file maintenance process includes a user identification process, responsive to the preference file creation process creating the advertisement preference file for the user, for transmitting to the user a unique identifier that associates the user with the appropriate advertisement preference file. The unique identifier is a cookie that is stored on a remote computer operated by the user.

The preference file maintenance process includes a preference file modification process for modifying the list of user-preferred advertisement categories to include the predefined advertisement categories associated with each monitored query entered by the user. The advertisement targeting process further includes a query storage process for storing the monitored queries in the advertisement preference file for later processing by the query association process. The advertisement targeting process further includes an advertisement repository for storing a plurality of advertisements grouped in accordance with the plurality of predefined advertisement categories.

The advertisement targeting process further includes an advertisement transmission process for accessing the plurality of advertisements stored on the advertisement repository and transmitting, to the user, advertisements in accordance with the list of user-preferred advertisement categories specified in the advertisement preference file for that user. The advertisement repository and the advertisement transmission process are incorporated into a remote advertisement service provider. The advertisements transmitted to the user are received by a remote computer operated by the user, wherein the remote computer executes a graphical program that allows the user to view the advertisements. The graphical program is a web browser. The remote computer executes an audio program that allows the user to hear the advertisements

The query association process includes a query parsing process for separating the query into one or more discrete chunks. The query association process includes a word association process for associating one of the plurality of predefined advertisement categories with one or more of the discrete chunks included in the query. The query association process includes a word categorization process for categorizing one or more of the discrete chunks included in the query into one of the plurality of predefined advertisement categories if it is determined that the one or more discrete chunks is not currently associated with any of the plurality of predefined advertisement categories. The query association process includes a word recategorization process for recategorizing one or more of the discrete chunks included in the query into a different predefined advertisement category if it is determined that the existing association of the one or more discrete chunks with its predefined advertisement category is no longer valid due to changes in the user's query patterns. The word association process is a manual association process.

According to a further aspect of this invention, an advertisement targeting method for determining the advertisement preferences of a user, includes monitoring the queries entered by a user and associating each monitored query with one or more predefined advertisement categories. Te method maintains, for each user, an advertisement preference file that specifies the predefined advertisement categories associated with each monitored query entered by the user, thus generating a list of user-preferred advertisement categories.

One or more of the following features may also be included. Maintaining an advertisement preference file includes determining if an advertisement preference file exists for that user. Maintaining an advertisement preference file includes creating the advertisement preference file for the user if it is determined that an advertisement preference file does not exist for that user. Maintaining an advertisement preference file includes transmitting to the user a unique identifier that associates the user with the appropriate advertisement preference file. Maintaining an advertisement preference file includes modifying the list of user-preferred advertisement categories to include the predefined advertisement categories associated with each monitored query entered by the user. The advertisement targeting method further includes storing the monitored queries in the advertisement preference file for later processing.

The advertisement targeting method further includes storing a plurality of advertisements grouped in accordance with the plurality of predefined advertisement categories. The advertisement targeting method further includes accessing the plurality of advertisements stored on the advertisement repository and transmitting, to the user, advertisements in accordance with the list of user-preferred advertisement categories specified in the advertisement preference file for that user. The advertisement targeting method further includes receiving, on a remote computer operated by the user, the advertisements transmitted to the user, wherein the remote computer executes a graphical program that allows the user to view the advertisements. Associating each monitored query includes separating the query into one or more discrete chunks. Associating each monitored query includes associating one of the plurality of predefined advertisement categories with one or more of the discrete chunks included in the query. Associating each monitored query includes categorizing one or more of the discrete chunks included in the query into one of the plurality of predefined advertisement categories if it is determined that the one or more discrete chunks is not currently associated with any of the plurality of predefined advertisement categories. Associating each monitored query includes recategorizing one or more of the discrete chunks included in the query into a different predefined advertisement category if it is determined that the existing association of the one or more discrete chunks with its predefined advertisement category is no longer valid due to changes in the user's query patterns.

According to a further aspect of this invention, a computer program product residing on a computer readable medium having a plurality of instructions stored thereon that, when executed by the processor, cause that processor to monitor the queries entered by a user and associate each monitored query with one or more predefined advertisement categories. The computer program product maintains, for each user, an advertisement preference file that specifies the predefined advertisement categories associated with each monitored query entered by the user, thus generating a list of user-preferred advertisement categories.

One or more of the following features may also be included. The computer readable medium is a random access memory (RAM), a read only memory (ROM), or a hard disk drive.

According to a further aspect of this invention, a processor and memory are configured to monitor the queries entered by a user and associate each monitored query with one or more predefined advertisement categories. The processor and memory maintain, for each user, an advertisement preference file that specifies the predefined advertisement categories associated with each monitored query entered by the user, thus generating a list of user-preferred advertisement categories.

One or more of the following features may also be included. The processor and memory are incorporated into a personal computer, a network server, or a single board computer.

One or more advantages can be provided from the above. Advertisements can be targeted so that the user is only provided with advertisements in the user's particular area of interest. By maintaining a unique preference file for each user, an averaged preference can be determined for each user which takes into account preference variations which occur over time. By utilizing an averaged preference, the type of advertising provided to the user won't drastically change in response to queries outside of a user's typical area of interest. Further, by utilizing this averaged preference, the advertisements provided to the user will be consistent with that user's particular area of interest, even though the user may perform an occasional search outside of that area of interest.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of the Internet;

FIG. 2 is a diagrammatic view of the advertisement targeting process;

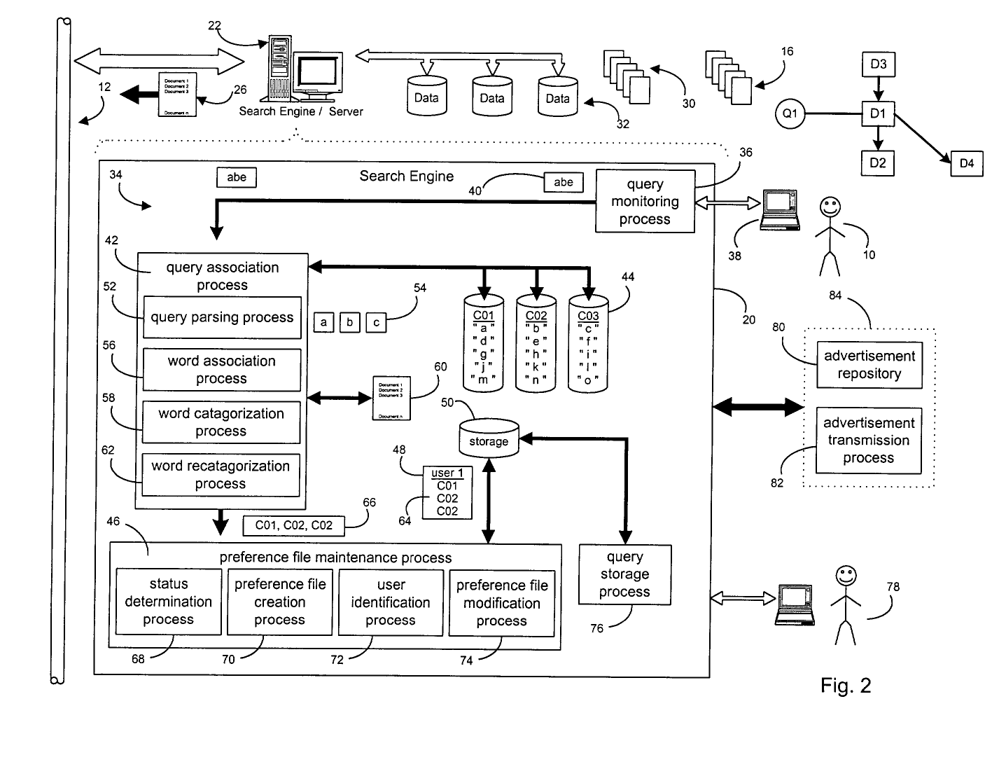

FIG. 3 is a flow chart of the advertisement targeting method;

FIG. 4. is a diagrammatic view of another embodiment of the advertisement targeting process, including a processor and a computer readable medium, and a flow chart showing a sequence of steps executed by the processor; and

FIG. 5. is a diagrammatic view of another embodiment of the advertisement targeting process, including a processor and memory, and a flow chart showing a sequence of steps executed by the processor and memory.

Like reference symbols in the various drawings indicate like elements.

### DETAILED DESCRIPTION

The Internet and the World Wide Web can be viewed as a collection of hyperlinked documents with search engines as a primary interface for document retrieval. Search engines (e.g., Lycos, Yahoo, Google) allow the user to enter a query and perform a search based on that query. A list of potential matches is then generated that provides links to potentially relevant documents. Search engines typically also offer to the user some form of taxonomy that allows the user to manually navigate to the information they wish to retrieve.

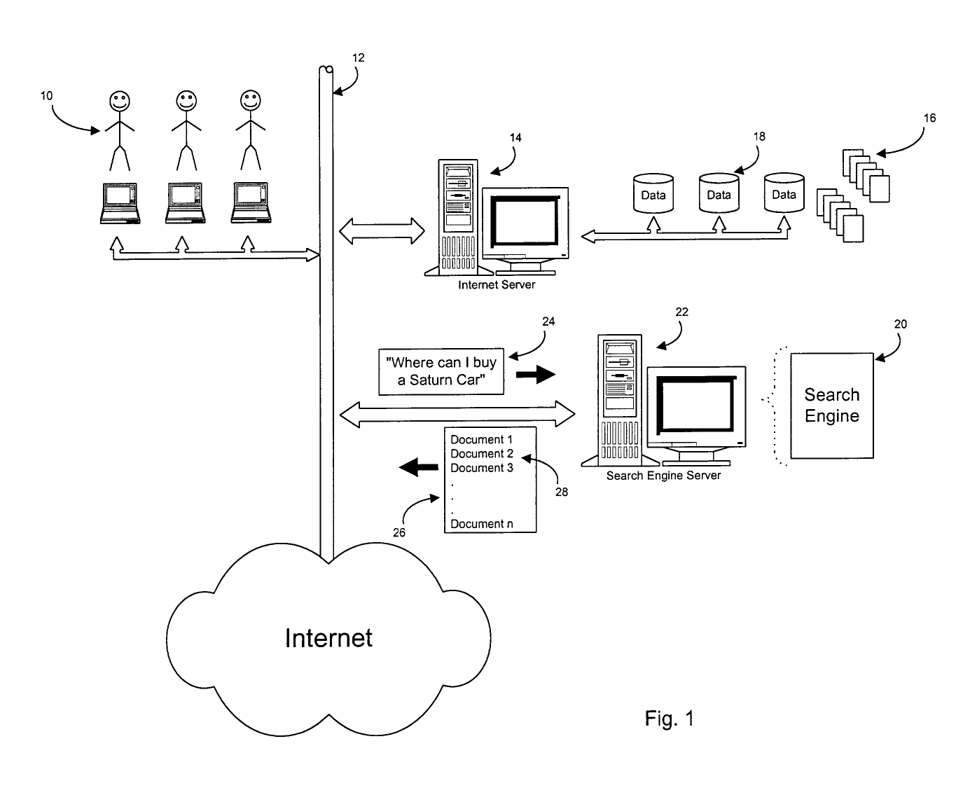

Referring to FIG. 1, there is shown a number of users 10 accessing the Internet via a network 12 that is connected to Internet server 14. The Internet server 14 serves web pages and Internet-based documents 16 to user 10. Internet server 14 typically incorporates some form of database 18 to store and serve documents 16.

When user 10 wishes to search for information on a specific topic, user 10 utilizes search engine 20 running on search engine server 22. User 10 enters query 24 into search engine 20, which provides a list 26 of potential sources for information related to the topic of query 24. For example, if user 10 entered the query “Where can I buy a Saturn Car?”, list 26 would be generated that enumerates a series of documents that provide information relating to the query entered, that is where the user can purchase Saturn cars. Each entry 28 on list 26 is a hyperlink to a specific relevant document (i.e., web page) 16 on the Internet. These documents 16 may be located on search engine server 22, Internet server 14, or any other server (not shown) on the Internet.

Search engine 20 determines the ranking of the entries 28 on list 26 by examining the documents themselves to determine certain factors, such as: the number of documents linked to each document; the number of documents that document is linked to; the presence of the query terms within the document itself; etc. This results in a score (not shown) being generated for each entry 28, such that these entries are ranked within list 26 in accordance with these scores.

Now referring to FIGS. 1 and. 2, there is shown search engine 20 that analyzes the hundreds of millions of documents 16 available to users of the Internet. These documents can be stored locally on server 22 or on any other server or combination of servers connected to network 12. As stated above, when search engine 20 provides list 26 to user 10 in response to query 24 being entered into search engine 20, the individual entries in list 26 are arranged in accordance with their perceived level of relevance (or match). This relevance level is determined in a number of different ways, each of which examines the relationship between various Internet objects (e.g., a query, a document, a web page, an ASCII file, etc.).

As a query contains specific search terms (e.g., “Where can I buy a Saturn Car?”), early search engines used to simply examine the number of times that each of these search terms appeared within the documents scanned by the search engine. Web designers typically incorporate hidden metatags into their web documents to bolster the position of their web page (or web-based document) on list 26. Metatags are lines of code that redundantly recite the specific search terms that, if searched for by a user, the designer would like their web page to be listed high in the list 26 of potentially matching documents. For example, if a web designer wanted their web page document to be ranked high in response to the query “Where can I buy a Saturn Car?”, the designer may incorporate a metatag that recites the words “Saturn” and “car” 100 times each. Therefore, when the search engine scans this document (which is typically done off line and not in response to a search by a user), the large number of occurrences of the words “Saturn” and “car” will be noted and stored in the search engine's database. Accordingly, when a user enters this query into search engine 20, the document that contains this metatag will be highly ranked on this list. As easily realized, since this method of ranking simply examines the number of times a specific term appears in a document, the method does not in any way gauge the quality of the document itself.

In response to this shortcoming, more sophisticated methods of ranking documents were developed that examined the quality of the documents themselves (as opposed to merely the number of times that a search term was embedded within the document's HTML code). These search engines rank the quality of documents by examining, among other things, the number of documents that are linked to the document being ranked. Specifically, if a document has a considerable number of documents linked to it, it is considered an information authority. For example, document D1 is an authority for document D3, since document D3 is linked to document D1. The theory behind this rule is that if good information is available on the Internet, people will link to it to bolster the substantive value of their own web site. Naturally, the greater the number of documents linked to the authority document being ranked, the stronger the authority value for that authority document.

However, web-based documents need not be information authorities to be valued by search engines. Search engine 20 will also examine, among other things, the number of documents that the document being ranked is linked to. Specifically, if a document is linked to a considerable number of documents, that document is considered an information hub. For example, document D1 is a hub in that it is linked to documents D2 and D4. The theory behind this rule is the same as the previous one, namely if good information is available on the Internet, it will be found and pointed (i.e., linked) to. Naturally, the greater the number of documents that the hub document being ranked is linked to, the stronger the hub value for that hub document.

The computation of a document's information authority and information hub values is more complex than the cursory description provided above. These values are determined by using an iterative process that initially sets the authority and hub values for each document to one. Multiple iterations are then performed, wherein the current authority and hub values are considered to be accurate and new authority and hub values are then computed based on these previously accepted values. Accordingly, a document that has many hubs pointing to it is given a higher authority weight in the next iteration. This algorithm continues until the authority and hub values each converge.

Please realize that the above-listed sorting and ranking methods are used both for ranking search results and for ordering indexes to be navigated manually. While the discussion was primarily focused on queries and search engines, these methods are also utilized to determine the placement of documents within manually navigated indexes.

Thus far, the relationships that the above-described methods have scrutinized have all been document-to-document relationships. However, search engines examine other criteria to further enhance the ranking of their documents. Specifically, search engines typically keep track of the queries that have been run on them and the list of hyperlinks generated as a result of each of these queries. Additionally, search engines monitor how often a user (for any given list and query) goes to a particular item on the list of search results; returns to the list after going to a document; and selects a different document. The theory behind this is that substantive quality information attracts users and, therefore, if a user follows a hyperlink to a document, it is indicative of quality information being available at that site. An example of scrutinizing this query-to-document criteria is as follows: user 10 issues query Q1; a list is generated which includes document D1, D2, and D3; user 10 selects document D1, user 10 then returns to the list; user 10 then selects document D2 and does not return. These actions by user 10 are indicative of low quality (or off topic) information being available in document D1 and high quality (or on topic) information being available in document D2. These queries are stored in the query records 30 on search engine database 32. The hyperlink lists generated in response to these queries and the statistics concerning the use of these links are also stored in database 32.

Search engines can further enhance their document ranking accuracy by comparing stored queries (query-to-query relationships) to make suggestions to the user concerning modifications or supplemental search terms that would better tailor the user's query to the specific information they are searching for. For example, if user 10 entered the query “Saturn” into search engine 20, it is unclear in which direction the user intends this search to proceed, as the word “Saturn” is indicative of a planet, a car company, and a home video game system. Upon reviewing query records 30 and determining that queries containing the word “Saturn” typically also include the words “planet”, “car”, or “game”, search engine 20 may make an inquiry to the user, such as “Are you looking for information concerning: the planet Saturn; the car Saturn; or the video game system Saturn?” Depending on which selection the user makes, the user's search will be modified and tailored accordingly. This further allows search engine 20 to return a relevant list of documents in response to a query being entered by the user 10.

Naturally, users of the Internet tend to run queries concerning their specific areas of interest. For example, people who are interested in music might search for information concerning the Beatles, people who are interested in cars might search for information concerning the Chevrolet Corvette, people who are interested in sports might search for information concerning the Boston Red Sox, etc. Additionally, people typically have multiple areas of interest and may search for information concerning multiple topics simultaneously.

People who are enthusiasts in any particular area (e.g., music enthusiast, car enthusiast, sports enthusiast, etc.) tend to purchase products relating to that particular area of interest. Accordingly, by monitoring the specific areas of interest of a particular user (or visitor) of a search engine, that user's particular areas of interest can be determined and, therefore, advertisements can be targeted to that particular user so that they reflect their particular area of interest. This is somewhat analogous to the theory that television and radio advertising follows, namely determine the demographic of the viewing or listening audience and tailor the advertisements so that they appeal to that particular area of interest. However, the Internet allows for a much higher level of tailoring, in that the specific likes of a single user can be monitored, as opposed to the likes of a specific demographic. Accordingly, since the queries that a user enters into a search engine tend to reflect that user's particular areas of interest, by monitoring and processing these queries, interest-specific Internet advertising (e.g., banner ads, pop-over ads, pop-under ads, embedded links, audio, video, etc.) can be provided to the user.

Advertisement targeting process 34, which determines the advertisement preferences of user 10, includes a query monitoring process 36 for monitoring the queries entered by the user. Typically, user 10 enters queries into search engine 20 via computer 38. The queries 40 monitored by query monitoring process 36 are then provided to query association process 42, which processes these queries 40 so that the entire query (or discrete portions of the query) can be associated with one of several predefined advertisement categories 44 (commonly referred to as buckets). These category associations represent the advertisement categories that user 10 prefers and/or is interested in. Advertisement targeting process 34 includes a preference file maintenance process 46 for creating and maintaining an advertisement preference file 48 for each user. This advertisement preference file 48 specifies the predefined advertisement categories associated with the query (or portions of the query) entered by user 10, thus defining that user's particular areas of interest concerning advertising. Additionally, since this advertisement preference file 48 is updated each time user 10 enters an additional query, this file 48 represents the user's preferences averaged over time. Specifically, since the user's particular areas of interest are monitored over an extended period of time (as opposed to just for a single query), a more accurate determination of a user's preferences is possible. This advertisement preference file 48 is typically stored on some form of storage device 50 (e.g., a hard drive, an optical drive, a tape drive, a RAID array, etc.).

Query association process 46 includes a query parsing process 52 for separating monitored query 40 into one or more discrete chunks. This enables query association process 46 to properly determine which of the plurality of predefined advertisement categories are associated with query 40 entered by user 10. For example, if user 10 entered the query “abe” into search engine 20, query monitoring process 36, which is monitoring all queries entered on search engine 20, would provide this monitored query 40 to query association process 42. Query parsing process 52 would then parse (or break apart) query 40 into one or more discrete chunks 54. Continuing with the above example, let's assume that the letters “a”, “b”, and “e” each represent a unique word. Accordingly, query parsing process 52 would break query 40 into three chunks (i.e., “a”, “b”, and “e”), each of which represent a word in the query.

Query association process 42 includes a word association process 56 for associating one of the plurality of predefined advertisement categories 44 with each one (or more) of these discrete chunks 54 included in query 40. Continuing with the above example, let's assume that there are three predefined advertisement categories, namely categories C01, C02, and C03. Please realize that this number of predefined advertisement categories is for illustrative purposes only and is not intended to be a limitation of the invention, as advertisement targeting process 34 typically utilizes thirty or more predefined advertisement categories. Each one of these categories is shown to include several keywords associated with that category. These are keywords that, when searched by the user, are indicative of that user being interested in that particular advertisement category or area of interest. This is based on the reasoning that a person that searches for information on a topic is most likely interested in that topic (e.g., a person that searches for information on cars is most likely interested in cars, a person that search for information on music is most likely interested in music, a person that search for information on sports is most likely interested in sports, etc.). Continuing with the above-stated example, category C01 is shown to include “a”, “d”, “g”, “i” and “m”, each of which represents a word or a group of words associated with that topic or area of interest. Again, this relatively few number of words is for illustrative purposes only. A good real-world example of these categories and their related words would be a category called “dogs” including the words “shepherd’, “dachshund”, “retriever”, spaniel”, “beagle”, “Labrador”, etc.

Since query 40 includes three words, namely “a”, “b”, and “e”, there will be a maximum of three associations with predefined advertisement categories 44. In this particular example, the word “a” is included in category C01, and the words “b” and “e” are included in category C02. Accordingly, word association process 56 determines that query 40 is associated with two categories, namely C01 and C02. Further, since query 40 contains two words (“b” and “e”) belonging to category C02 and only one word (“a”) belonging to category C01, category C02 is statistically more relevant to query 40 than category C01. Accordingly, the advertisement preference file 48 generated for this particular user will indicate a higher level of proclivity for advertisements in category C02. This can be accomplished in several ways, such as assigning a statistical weight to each entry or listing the actual number of times that each category was associated with a chunk of a user's query. Expanding on the above-stated example, in query 40 entered by user 10, out of a total of three query chunks 54, a term in category C01 matched once and a term in category C02 matched twice. Accordingly, category C02 would be considered twice as related (or associated) with query 40 as category C01. Therefore, when ranking these categories, a relevancy score (not shown) would be associated with each category. In this particular example, category C02 would have a relevancy score of 0.67 and category C01 would have a relevancy score of 0.33. Alternatively, category C02 can have a relevancy score of two, while category C01 can have a relevancy score of one. These are but a few examples of the many ways in which the relevancy levels can be monitored.

It is important to note that the chunks 54 that query 40 is broken up into need not be discrete words, as query association process 42 may be designed to recognize common phrases or groups of words. For example, if user 10 typed in the query “German shepherd”, this phrase would clearly be associated with a category relating to pets generally and dogs specifically. However, if this query were broken up into discrete words, namely “German” and “shepherd”, “German” would probably be associated with a category relating to ethnicity and “shepherd” would probably be associated with a category relating to livestock or agriculture. Therefore, it is possible for a phrase to have a totally different meaning than the individual words which make up the phrase. Accordingly, query parsing process 52 could be configured to not parse well-known phrases (e.g., “German Shepherd”) into individual words. Alternatively, word association process 56 could be configured so that parsed well-known phrases can be recombined when the associations are established between the predefined advertisement categories 44 and the query chunks 54. Further and alternatively, these well-known phrases could be stored as phrases within their respective predefined advertisement categories 44.

It is important to realize that the specific words or phrases (i.e., the keywords) associated with each of the predefined advertisement categories 44 are not static and are constantly evolving. Accordingly, query association process 42 includes a word categorization process 58 for automatically categorizing any discrete chunk included in a query that has not already been associated with any of the predefined advertisement categories 44. Unfortunately, due to the number of categories employed, the number of searches entered into the average search engine, and the large and ever-changing list of keywords associated with each category 44, an automated categorization process must be employed, as manual categorization would quickly prove to be unmanageable. Naturally, in order for this automated word categorization process 58 to occur and function properly, when a category is established, an initial set of keywords has to be defined for that category. For example, if the category was “baseball”, the initial set of keywords associated with that category might be the names of all the major league baseball teams. However, in light of the fact that expansion teams are always being formed, this list of keywords will most-likely have to be updated periodically. Accordingly, whenever word association process 56 encounters a chunk 54 which is not associated with any of the predefined advertisement categories 44 (i.e., this chuck is not a keyword of any of the categories 44), word categorization process 58 will attempt to categorize this word or phase by performing some form of analysis, such as a co-query analysis or a directory analysis.

Continuing with the above-stated example, if query 40 included a fourth word or phrase, namely “z”, it is clear that this word or phrase is not listed as a keyword in any of the categories (i.e., categories C01, C02, and C03). Accordingly, this word may be categorized by word categorization process 58 and the list of keywords associated with the appropriate category appended to include this word or phrase.

In order to categorize the uncategorized chunk, word categorization process 58 may examine the words that this chunk is currently being searched with. For example, if user 10 enters a query that includes several recognized chunks (all pop-music stars) and one unrecognized chunk (a new pop-music star who is not yet popular or well-known), it is highly likely that the unrecognized chunk has something to do with pop-music. Accordingly, this unrecognized chunk would be categorized in the same category as the other pop-music chunks. When you consider that search engines handle millions of searches per day, this method of categorization becomes highly accurate when taken out over an extended period of time.

Another method that can be employed by word categorization process 58 to categorize an uncategorized chunk is known as co-query analysis. Queries are considered co-queries if users tend to ask the two queries together within the same session, in that a session is a consecutive sequence of queries issued by a user of a search engine.

To decide whether two queries (e.g., Q1 and Q2) are co-queries, we count the number of user sessions in which the user asked both Q1 and Q2. If this number of sessions is significantly higher than what we would expect by chance, then we say that queries Q1 and Q2 are co-queries. The number of sessions that we would expect by chance is simply the total number of sessions multiplied by the fraction of sessions that contain query Q1 multiplied by the fraction of sessions that contain query Q2. That is, we assume that the occurrence of query Q1 in a user session is independent of the occurrence of query Q2 in a user session.

We can measure the degree to which the observed number of sessions differs from the expected number of sessions by using any technique for evaluating a ratio between an observed number of events and an expected number of events (e.g., mutual information analysis, a chi-squared test, etc.). For example, consider the queries “German shepherd” and “guard dog”. If we analyze the user sessions stored in query records 30 on search engine database 32, let's say we find that “German shepherd” occurs in 0.015% of the user sessions, and “guard dog” occurs in 0.024% of the sessions. We would then expect, by chance, the queries to occur together 0.015%*0.024% or 0.00000360% of the sessions. However, we in fact observe that the queries occur together in 0.0008% of the sessions. Because this number is much larger than what we would expect if the two terms were independent, we conclude that they are co-queries.

Accordingly, if user 10 enters the query “German shepherd” and the phrase “German shepherd” is not categorized, word categorization process 58 could apply this co-query knowledge to categorize this phrase. Specifically, since the query “German Shepherd” is searched with the query “guard dog” (in a single search session by a single user) at a rate substantially higher than would be anticipated in a truly random system, these queries are considered co-queries and, therefore, the phrase “German shepherd” would be categorized in the same category as the phrase “guard dog”.

Alternatively, an unknown chunk can be categorized using a method known as open directory categorization. Specifically and as stated above, searches engines typically employ some form of navigation index to assist the searcher in finding topical information relevant their area of interest. These indices on the higher level have relatively few very broad topics. Much like the branches of a tree, as you traverse through the indices' hierarchy, these topics (on the lower level) quickly multiply in number but the scope of each topic shrinks in size. This results in a large number of narrow subtopics. These topics and subtopics are arranged in a similar fashion to that of a directory on a computer's hard drive, in that the topics each have a group of subtopics, where each subtopic each has its own group of subtopics, and so on. When word categorization process 58 utilizes the open directory categorization process to categorize unrecognized chunks, categorization process 58 generates a look-up table 60 that maps each low level subtopic to a specific predefined advertisement category 44. Alternatively, this table 60 may be predefined. Naturally, the depth to which these topics and subtopics are mapped is directly proportional to the level of accuracy required by advertisement targeting process 34 and the number of predefined advertisement categories 44. Once this mapping is complete and look-up table 60 is available to word categorization process 58, a search of the search engine's indices (not shown) is performed by search engine 20 using the uncategorized chunk of query 40 entered by user 10. This results in a list of relevant documents 26, each of which specifies the specific topic and subtopic to which that document belongs. Accordingly, since each of these topics/subtopics is mapped to a specific predefined advertisement category 44, the uncategorized chunk can now be categorized by aggregating the categorization information corresponding to each of the relevant documents 26.

Once an uncategorized chunk can be categorized, word categorization process 58 appends the list of keywords associated with that category 44 so that it includes the previously uncategorized keyword.

Please realize that the above-stated query analysis methods (e.g., same query analysis, co-query analysis, and open directory analysis) are for illustrative purposes only and are not intended to be a limitation of the invention, as this list is merely intended to set forth examples and is not intended to be all-inclusive or encompassing. For example, it is possible to manually categorize each word/phrase and, therefore, manually append the appropriate category to include that word/phrase. Accordingly, word association process 56 may be a manual association process in which an administrator specifies the specific words/phrases to be included in a specific category.

What must be realized is that simply because a word or phase has been categorized does not mean that that categorization will never change. For example, prior to 1997, the term “Titanic” would probably have been categorized in a history category, as it was the proper name of an ocean liner that sank in the North Atlantic Ocean after striking an iceberg in 1912. However, with the release of the popular movie “Titanic” in 1997, the term Titanic would probably be categorized, at least temporarily, in an entertainment category. Therefore, the keywords associated with the predefined advertisement categories 44 have to be flexible to accurately reflect the current usage of a word.

Accordingly, query association process 42 includes a word recategorization process 62 for performing “housekeeping” on the plurality of predefined advertisement categories 44 and their related keywords. Specifically, word recategorization process 62 will routinely and systematically evaluate the categorization of each keyword associated with each predefined advertisement category 44 using one of the methods described above (or a similar method). This process 62 may be performed piecemeal on only the chunks 54 analyzed by word association process 56. Alternatively, word recategorization process 62 may function as a stand-alone process and evaluate the categorizations of all the keywords of all the categories 44 at a time when server usage is low, thus minimizing the loading of the server 22.

In the event that word recategorization process 62 determines that a categorization of a specific keyword is no longer valid (or never was valid), the incorrectly categorized keyword can be deleted from the list of keywords for the category it was improperly associated with and added to the list of keywords for the category it should be associated with.

Please realize that there are some words that are so generic that they cannot be categorized. Amongst these words are: “and”; “to”; “it”; “the”; “is”; “as”; “I”; “we”, and so forth. Accordingly, since these words do not provide any substantive value or insight concerning the areas of interest of the user, these words are not processed or categorized and, therefore, do not affect the user's advertisement preference file 48. However, in the event that one of the above-listed generic words is incorporated into a recognized phrase (e.g., “Jack in the Box”), the generic word would not be parsed from the phrase and, therefore, the phrase would be processed in its entirety.

Once query association process 42 associates the chunks 54 of the query 40 parsed by query parsing process 52 with one or more of the predefined advertisement categories 44, this information 66 is provided to preference file maintenance process 46. As stated above, preference file maintenance process 46 maintains, for each said user, an advertisement preference file 48 that specifies the predefined advertisement categories 44 associated with each query 40 entered by user 10. Therefore, advertisement preference file 48 includes a list of user-preferred advertisement categories 64. Accordingly, if user 10 executes searches for pop-music stars, their user-preferred advertisement categories 64 would be related to pop-music. Further, if one out of every four searches executed by user 10 concerned automobiles, the user-preferred advertisement categories 64 for user 10 would be both pop-music and automobiles, such that the comparative weight of pop-music stars is three times greater than that of automobiles.

When preference file maintenance process 46 receives information 66 concerning the user's user-preferred advertisement categories 64, preference file maintenance process 46 must first determine if there is an existing advertisement preference file 48 for that user (i.e., determine whether the user is an existing user or a new user). Accordingly, preference file maintenance process 46 includes a status determination process 68 for making this determination. The determination is made by examining the computer 38 that user 10 is using to access search engine 20. In the event that user 10 is an existing user, a unique identifier (not shown) will be present on the local hard drive of computer 38. Alternatively, if user 10 is a new user, this unique identifier will not be present on computer 38. Typically, the unique identifier is a file (e.g., a cookie) that specifies a unique account number for user 10. Technically, this unique identifier provides an account number for the computer as opposed to the actual user, as the unique identifier has no way of knowing who actually is sitting at the computer. However, when computer 38 is running an operating system that allows for multiple user profiles (e.g., Microsoft Windows®) and, therefore, multiple users, a unique identifier may be stored in the profile directory for each user. This allows for the storing of multiple unique identifiers (each of which corresponds to one user profile) on a single computer.

Accordingly, status determination process 68 determines if user 10 is a new user or an existing user by determining if the appropriate unique identifier (i.e., the cookie) was transmitted to advertisement targeting process 34. In the event that the cookie was transmitted, user 10 is an existing user. If this is the case, status determination process 68 will read the existing cookie to determine the existing user's account number, so that the appropriate advertisement preference file 48 can be accessed from storage device 50. However, in the event that a cookie was not transmitted, status determination process 68 will consider user 10 to be a new user.

When status determination process 68 determines that user 10 is a new user, a new account must be established for this new user. Accordingly, preference file maintenance process 46 includes a preference file creation process 70. Specifically, each time a new user (as determined by status determination process 68) executes a query for the first time on search engine 20, preference file maintenance process 46 initializes and configures an account for that new user. During the account initialization and configuration process, preference file creation process 70 creates a blank advertisement preference file (not shown) into which the information 66 concerning the user's preferred advertisement categories 64 is inserted, resulting in a complete advertisement preference file 48 being created for that user.

Preference file maintenance process 46 also includes a user identification process 72, which is responsive to preference file creation process 70 creating an advertisement preference file 48 for user 10. Specifically, when preference file creation process 70 creates an advertisement preference file (which at this point contains information 66), user identification process 72 establishes an account for that new user and identifies the newly-created advertisement preference file 48 as belonging to this account (and, therefore, the new user). User identification process 72 will configure a cookie to specify this newly-created account number and transmit this cookie to the computer 38 that user 10 is accessing search engine 20 from. This cookie is then stored on the local hard drive of computer 38 so that the next time user 10 executes a query on the search engine, this cookie can be transmitted to advertisement targeting process 34. This enables status determination process 68 to determine that user 10 has an existing account. Therefore, an advertisement preference file 48 for that user will exist on storage device 50.

As stated above, each time a query is entered by user 10, query association process, via various sub-processes, parses query 40 into various chunks 54 which are then associated with predefined advertisement categories 44, thus generating information 66 concerning the user's user-preferred advertisement categories 64. Whenever preference file maintenance process 46 receives information 66, status determination process 68 will then determine if there is an existing advertisement preference file 48 for that user (i.e., determine whether the user is an existing user or a new user). If it is determined that user 10 is an existing user and, therefore, has an existing account and an advertisement preference file 48, preference file maintenance process 74 will then access the advertisement preference file 48 associated with this existing account (and user) so that this file can be modified to include information 66. Specifically, as stated above, advertisement preference file 48 includes a list of user-preferred advertisement categories 64, in that for an existing user, this list would reflect areas of interest concerning previous queries executed by user 10 on search engine 20. This list 64 will then be modified to reflect this newly-determined information 66. Typically, information 66 will be appended to list 64 and the weight of each category included in this list will be modified to accurately reflect the new category ratios.

As would be imagined, processing every query executed on search engine 20 requires a considerable amount of processing, especially in light of the fact that these search engines may execute millions of queries per day. Accordingly, advertisement targeting process 34 may include a query storage process 76 for storing, on storage device 50, the queries entered into search engine 20 by user 10. This would allow the processing of these queries to be delayed until a time that minimizes server loading. Typically, search engine usage is at its highest during business hours and at its lowest in the middle of the night. Further, this batch query processing could be configured to occur at a periodicity (nightly, weekly, monthly, etc.) specified by an administrator 78.

As described above, advertisement targeting process 34 allows for the creation and maintenance of an advertisement preference files 48 for each user 10 entering a query 40 into search engine 20. These advertisement preference files specify the areas of interest for that particular user. Accordingly, by understanding the areas in which a particular user is interested, area-specific advertising can be targeted and transmitted to that user. Advertisement targeting process 34 includes a file repository process 80 for storing advertisements grouped in accordance with predefined advertisement categories 44. Thus, if user 10 runs a considerable number of searches (i.e. executes queries) relating to automobiles, they are most-likely a car enthusiast. Therefore, advertisement preference file 48 would specify an area of interest for user 10 as being automobiles. Therefore, user 10 would probably be interested is seeing ads relating to various automobiles and automobile related products (e.g., automotive accessories, high performance driving schools, etc.).

An advertisement transmission process 82 processes the advertisement preference file 48 for user 10, retrieves the appropriate category-specific advertisements from advertisement repository 80 and transmits these advertisements to user 10 so they can be viewed/heard on user's computer 38. Typically, the advertisements stored in advertisement repository 80 are in the form of banner ads, text promotions, animations, videos, etc. that are viewable on computer 38 via some form of graphical program (not shown), such as a web browser (e.g., Internet Explorer®, Netscape Navigator®, etc.). Additionally, audio ads may be transmitted to computer 38 for playback by an audio program (not shown), such as a MIDI player, an AVI player, a Real player, an MP3 player, etc. While thus far, advertisement repository 80 and advertisement transmission process 82 have been discussed as being part of advertisement targeting process 34, this need not be the case. Advertisement repository 80 and advertisement transmission process 82 may be incorporated into some form of remote advertisement service process (e.g., Doubleclick®, etc.).

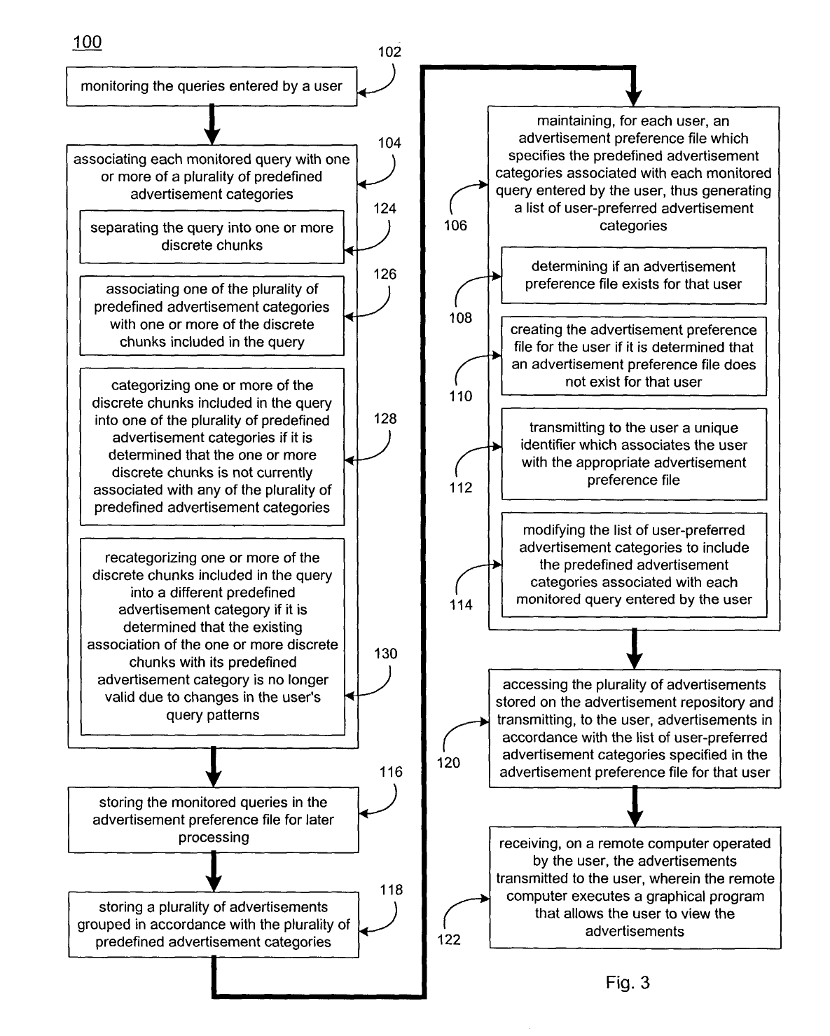

Now referring to FIG. 3, there is shown an advertisement targeting method 100 for determining the advertisement preferences of a user. A query monitoring process monitors 102 the queries entered by a user. A query association process associates 104 each monitored query with one or more predefined advertisement categories. A preference file maintenance process maintains 106, for each user, an advertisement preference file that specifies the predefined advertisement categories associated with each monitored query entered by the user. This generates a list of user-preferred advertisement categories.

A status determination process determines 108 if an advertisement preference file exists for that user. A preference file creation process creates 110 the advertisement preference file for the user if it is determined that an advertisement preference file does not exist for that user. A user identification process transmits 112 to the user a unique identifier that associates the user with the appropriate advertisement preference file. A preference file maintenance process modifies 114 the list of user-preferred advertisement categories to include the predefined advertisement categories associated with each monitored query entered by the user. A query storage process stores 116 the monitored queries in the advertisement preference file for later processing. An advertisement repository stores 118 a plurality of advertisements grouped in accordance with the plurality of predefined advertisement categories. An advertisement transmission process accesses 120 the plurality of advertisements stored on the advertisement repository and transmits, to the user, advertisements in accordance with the list of user-preferred advertisement categories specified in the advertisement preference file for that user. A remote computer receives 122 the advertisements transmitted to the user. This remote computer executes a graphical program that allows the user to view the advertisements. A query parsing process separates 124 the query into one or more discrete chunks. A word association process associates 126 one of the plurality of predefined advertisement categories with one or more of the discrete chunks included in the query. A word categorization process categorizes 128 one or more of the discrete chunks included in the query into one of the plurality of predefined advertisement categories if it is determined that the one or more discrete chunks is not currently associated with any of the plurality of predefined advertisement categories. A query association process recategorizes 130 one or more of the discrete chunks included in the query into a different predefined advertisement category if it is determined that the existing association of the one or more discrete chunks with its predefined advertisement category is no longer valid due to changes in the user's query patterns.

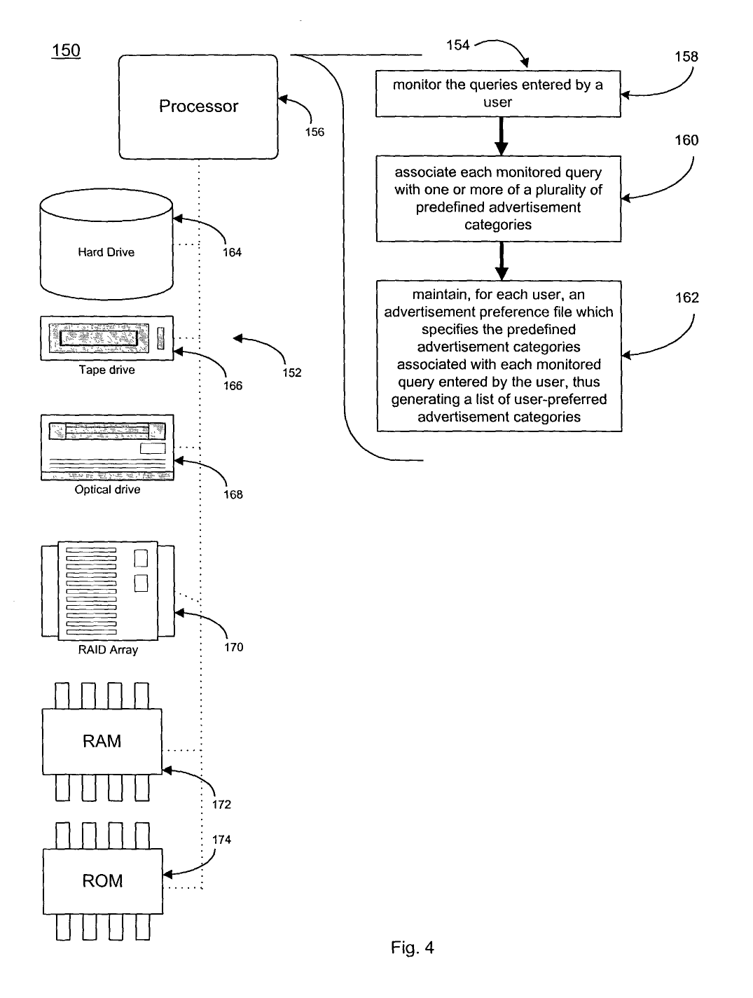

Now referring to FIG. 4, there is shown a computer program product 150 residing on a computer readable medium 152 having a plurality of instructions 154 stored thereon. When executed by processor 156, instructions 154 cause processor 156 to monitor 158 the queries entered by a user. Computer program product 150 associates 160 each monitored query with one or more predefined advertisement categories. Computer program product 150 then maintains 162, for each user, an advertisement preference file which specifies the predefined advertisement categories associated with each monitored query entered by the user, thus generating a list of user-preferred advertisement categories.

Typical embodiments of computer readable medium 152 are: hard drive 164; tape drive 166; optical drive 168; RAID array 170; random access memory 172; and read only memory 174.

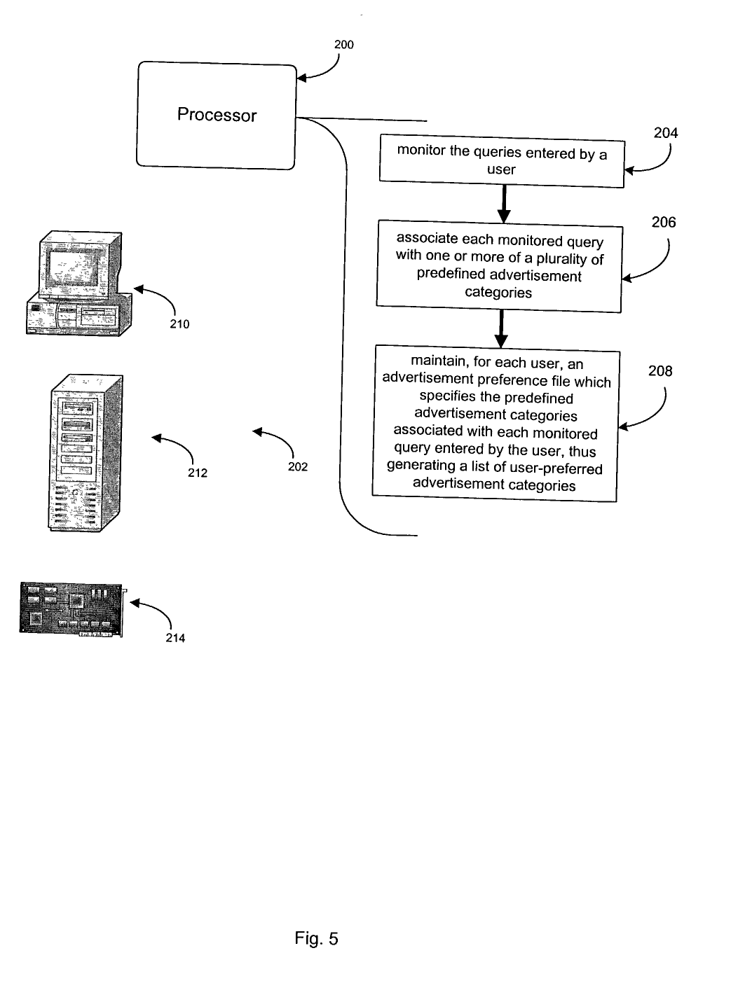

Now referring to FIG. 5, there is shown a processor 200 and memory 202 configured to monitor 204 the queries entered by a user analyze. Processor 200 and memory 202 associate 206 each monitored query with one or more predefined advertisement categories. Processor 200 and memory 202 then maintain 208, for each user, an advertisement preference file which specifies the predefined advertisement categories associated with each monitored query entered by the user, thus generating a list of user-preferred advertisement categories.

Processor 200 and memory 202 may be incorporated into a personal computer 210, a network server 212, or a single board computer 214.

A number of embodiments of the invention have been described. Nevertheless, it will be understood that various modifications may be made without departing from the spirit and scope of the invention. Accordingly, other embodiments are within the scope of the following claims.

What is claimed is:

1. An advertisement targeting process for determining the advertisement preferences of a user, comprising:
a query monitoring process for monitoring queries entered by users;
a query association process for associating each said monitored query with one or more predefined advertisement categories; and
a preference file maintenance process for maintaining, for each said user, an advertisement preference file that specifies said predefined advertisement categories associated with each said monitored query entered by said user, thus generating a list of user-preferred advertisement categories.

2. The advertisement targeting process of claim 1 wherein said preference file maintenance process includes a status determination process for determining if an advertisement preference file exists for said user.

3. The advertisement targeting process of claim 2 wherein said preference file maintenance process includes a preference file creation process, responsive to said status determination process, for creating said advertisement preference file for said user if it is determined that an advertisement preference file does not exist for that user.

4. The advertisement targeting process of claim 3 wherein said preference file maintenance process includes a user identification process, responsive to said preference file creation process creating said advertisement preference file for said user, for transmitting to said user a unique identifier that associates said user with the appropriate advertisement preference file.

5. The advertisement targeting process of claim 4 wherein said unique identifier is a cookie that is stored on a remote computer operated by said user.

6. The advertisement targeting process of claim 2 wherein said preference file maintenance process includes a preference file modification process for modifying said list of user-preferred advertisement categories to include said predefined advertisement categories associated with each said monitored query entered by said user.

7. The advertisement targeting process of claim 1 further including a query storage process for storing said monitored queries in said advertisement preference file for later processing by said query association process.

8. The advertisement targeting process of claim 1 further including an advertisement repository for storing a plurality of advertisements grouped in accordance with said predefined advertisement categories.

9. The advertisement targeting process of claim 8 further including an advertisement transmission process for accessing said plurality of advertisements stored on said advertisement repository and transmitting, to said user, advertisements in accordance with said list of user-preferred advertisement categories specified in said advertisement preference file for that user.

10. The advertisement targeting process of claim 9 wherein said advertisement repository and said advertisement transmission process are incorporated into a remote advertisement service process.

11. The advertisement targeting process of claim 9 wherein said advertisements transmitted to said user are received by a remote computer operated by said user, wherein said remote computer executes a graphical program that allows said user to view said advertisements.

12. The advertisement targeting process of claim 11 wherein said graphical program is a web browser.

13. The advertisement targeting process of claim 9 wherein said advertisements transmitted to said user are received by a remote computer operated by said user, wherein said remote computer executes an audio program that allows said user to hear said advertisements.

14. The advertisement targeting process of claim 1 wherein said query association process includes a query parsing process for separating said query into one or more discrete chunks.

15. The advertisement targeting process of claim 14 wherein said query association process includes a word association process for associating one of said predefined advertisement categories with one or more of said discrete chunks included in said query.

16. The advertisement targeting process of claim 14 wherein said query association process includes a word categorization process for categorizing one or more of said discrete chunks included in said query into one of said predefined advertisement categories if it is determined that said one or more discrete chunks is not currently associated with any of said predefined advertisement categories.

17. The advertisement targeting process of claim 16 wherein said query association process includes a word recategorization process for recategorizing one or more of said discrete chunks included in said query into a different predefined advertisement category if it is determined that the existing association of said one or more discrete chunks with its predefined advertisement category is no longer valid due to changes in the user's query patterns.

18. The advertisement targeting process of claim 15 wherein said word association process is a manual association process.

19. An advertisement targeting process for determining the advertisement preferences of a user, comprising:
a query monitoring process for monitoring queries entered by users;
a query storage process for storing said monitored queries in an advertisement preference file for that said user;
a query association process for associating each said monitored query stored in said advertisement preference file with one or more predefined advertisement categories;
a preference file maintenance process for maintaining, for each said user, said advertisement preference file so that it specifies said predefined advertisement categories associated with each said monitored query entered by said user, thus generating a list of user-preferred advertisement categories.

20. The advertisement targeting process of claim 19 wherein said preference file maintenance process includes a status determination process for determining if an advertisement preference file exists for said user.

21. The advertisement targeting process of claim 20 wherein said preference file maintenance process includes a preference file creation process, responsive to said status determination process, for creating said advertisement preference file for said user if it is determined that an advertisement preference file does not exist for that user.

22. The advertisement targeting process of claim 21 wherein said preference file maintenance process includes a user identification process, responsive to said preference file creation process creating said advertisement preference file for said user, for transmitting to said user a unique identifier that associates said user with the appropriate advertisement preference file.

23. The advertisement targeting process of claim 22 wherein said unique identifier is a cookie that is stored on a remote computer operated by said user.

24. The advertisement targeting process of claim 20 wherein said preference file maintenance process includes a preference file modification process for modifying said list of user-preferred advertisement categories to include said predefined advertisement categories associated with each said monitored query entered by said user.

25. The advertisement targeting process of claim 19 further including an advertisement repository for storing a plurality of advertisements grouped in accordance with said predefined advertisement categories.

26. The advertisement targeting process of claim 25 further including an advertisement transmission process for accessing said plurality of advertisements stored on said advertisement repository and transmitting, to said user, advertisements in accordance with said list of user-preferred advertisement categories specified in said advertisement preference file for that user.

27. The advertisement targeting process of claim 26 wherein said advertisement repository and said advertisement transmission process are incorporated into a remote advertisement service provider.

28. The advertisement targeting process of claim 26 wherein said advertisements transmitted to said user are received by a remote computer operated by said user, wherein said remote computer executes a graphical program that allows said user to view said advertisements.

29. The advertisement targeting process of claim 28 wherein said graphical program is a web browser.

30. The advertisement targeting process of claim 19 wherein said query association process includes a query parsing process for separating said query into one or more discrete chunks.

31. The advertisement targeting process of claim 30 wherein said query association process includes a word association process for associating one of said predefined advertisement categories with one or more of said discrete chunks included in said query.

32. The advertisement targeting process of claim 30 wherein said query association process includes a word categorization process for categorizing one or more of said discrete chunks included in said query into one of said predefined advertisement categories if it is determined that said one or more discrete chunks is not currently associated with any of said predefined advertisement categories.

33. The advertisement targeting process of claim 32 wherein said query association process includes a word recategorization process for recategorizing one or more of said discrete chunks included in said query into a different predefined advertisement category if it is determined that the existing association of said one or more discrete chunks with its predefined advertisement category is no longer valid due to changes in the user's query patterns.

34. An advertisement targeting process for determining the advertisement preferences of a user, comprising:
a query monitoring process for monitoring queries entered by users;
a query association process for associating each said monitored query with one or more predefined advertisement categories; and
a preference file maintenance process for maintaining, for each said user, an advertisement preference file that specifies said predefined advertisement categories associated with each said monitored query entered by said user, thus generating a list of user-preferred advertisement categories;
wherein said preference file maintenance process includes a status determination process for determining if an advertisement preference file exists for said user.

35 The advertisement targeting process of claim 34 wherein said preference file maintenance process includes a preference file creation process, responsive to said status determination process, for creating said advertisement preference file for said user if it is determined that an advertisement preference file does not exist for that user.

36. The advertisement targeting process of claim 35 wherein said preference file maintenance process includes a user identification process, responsive to said preference file creation process creating said advertisement preference file for said user, for transmitting to said user a unique identifier that associates said user with the appropriate advertisement preference file.

37. The advertisement targeting process of claim 36 wherein said unique identifier is a cookie that is stored on a remote computer operated by said user.

38. The advertisement targeting process of claim 34 wherein said preference file maintenance process includes a preference file modification process for modifying said list of user-preferred advertisement categories to include said predefined advertisement categories associated with each said monitored query entered by said user.

39. An advertisement targeting process for determining the advertisement preferences of a user, comprising:
a query monitoring process for monitoring queries entered by users;
a query association process for associating each said monitored query with one or more predefined advertisement categories;
a preference file maintenance process for maintaining, for each said user, an advertisement preference file that specifies said predefined advertisement categories associated with each said monitored query entered by said user, thus generating a list of user-preferred advertisement categories; and
an advertisement repository for storing a plurality of advertisements grouped in accordance with said predefined advertisement categories.

40. The advertisement targeting process of claim 39 further including an advertisement transmission process for accessing said plurality of advertisements stored on said advertisement repository and transmitting, to said user, advertisements in accordance with said list of user-preferred advertisement categories specified in said advertisement preference file for that user.

41. The advertisement targeting process of claim 40 wherein said advertisement repository and said advertisement transmission process are incorporated into a remote advertisement service provider.

42. The advertisement targeting process of claim 40 wherein said advertisements transmitted to said user are received by a remote computer operated by said user, wherein said remote computer executes a graphical program that allows said user to view said advertisements.

43. The advertisement targeting process of claim 42 wherein said graphical program is a web browser.

44. An advertisement targeting process for determining the advertisement preferences of a user, comprising:
a query monitoring process for monitoring queries entered by users;
a query association process for associating each said monitored query with one or more predefined advertisement categories; and
a preference file maintenance process for maintaining, for each said user, an advertisement preference file that specifies said predefined advertisement categories associated with each said monitored query entered by said user, thus generating a list of user-preferred advertisement categories;
wherein said query association process includes a query parsing process for separating said query into one or more discrete chunks.

45. The advertisement targeting process of claim 44 wherein said query association process includes a word association process for associating one of said predefined advertisement categories with one or more of said discrete chunks included in said query.

46. The advertisement targeting process of claim 44 wherein said query association process includes a word categorization process for categorizing one or more of said discrete chunks included in said query into one of said predefined advertisement categories if it is determined that said one or more discrete chunks is not currently associated with any of said predefined advertisement categories.

47. The advertisement targeting process of claim 46 wherein said query association process includes a word recategorization process for recategorizing one or more of said discrete chunks included in said query into a different predefined advertisement category if it is determined that the existing association of said one or more discrete chunks with its predefined advertisement category is no longer valid due to changes in the user's query patterns.

48. An advertisement targeting method for determining the advertisement preferences of a user, comprising:
monitoring queries entered by users;
associating each monitored query with one or more predefined advertisement categories; and
maintaining, for each user, an advertisement preference file that specifies the predefined advertisement categories associated with each monitored query entered by the user, thus generating a list of user-preferred advertisement categories.

49. The advertisement targeting method of claim 48 wherein maintaining an advertisement preference file includes determining if an advertisement preference file exists for that user.

50. The advertisement targeting method of claim 49 wherein maintaining an advertisement preference file includes creating the advertisement preference file for the user if it is determined that an advertisement preference file does not exist for that user.

51. The advertisement targeting method of claim 50 wherein maintaining an advertisement preference file includes transmitting to the user a unique identifier that associates the user with the appropriate advertisement preference file.

52. The advertisement targeting method of claim 49 wherein maintaining an advertisement preference file includes modifying the list of user-preferred advertisement categories to include the predefined advertisement categories associated with each monitored query entered by the user.

53. The advertisement targeting method of claim 48 further including storing the monitored queries in the advertisement preference file for later processing.

54. The advertisement targeting method of claim 48 further including storing a plurality of advertisements grouped in accordance with the plurality of predefined advertisement categories.

55. The advertisement targeting method of claim 54 further including accessing the plurality of advertisements stored on the advertisement repository and transmitting, to the user, advertisements in accordance with the list of user-preferred advertisement categories specified in the advertisement preference file for that user.

56. The advertisement targeting method of claim 55 further including receiving, on a remote computer operated by the user, the advertisements transmitted to the user, wherein the remote computer executes a graphical program that allows the user to view the advertisements.

57. The advertisement targeting method of claim 48 wherein associating each monitored query includes separating the query into one or more discrete chunks.

58. The advertisement targeting method of claim 57 wherein associating each monitored query includes associating one of the plurality of predefined advertisement categories with one or more of the discrete chunks included in the query.

59. The advertisement targeting method of claim 57 wherein associating each monitored query includes categorizing one or more of the discrete chunks included in the query into one of the plurality of predefined advertisement categories if it is determined that the one or more discrete chunks is not currently associated with any of the plurality of predefined advertisement categories.

60. The advertisement targeting method of claim 59 wherein associating each monitored query includes recategorizing one or more of the discrete chunks included in the query into a different predefined advertisement category if it is determined that the existing association of the one or more discrete chunks with its predefined advertisement category is no longer valid due to changes in the user's query patterns.

61. A computer program product residing on a computer readable medium having a plurality of instructions stored thereon that, when executed by the processor, cause that processor to:
monitor queries entered by users;
associate each monitored query with one or more predefined advertisement categories; and
maintain, for each user, an advertisement preference file that specifies the predefined advertisement categories associated with each monitored query entered by the user, thus generating a list of user-preferred advertisement categories.

62. The computer program product of claim 61 wherein said computer readable medium is a random access memory (RAM).

63. The computer program product of claim 61 wherein said computer readable medium is a read only memory (ROM).

64. The computer program product of claim 61 wherein said computer readable medium is a hard disk drive.

65. A processor and memory configured to:
monitor queries entered by users;
associate each monitored query with one or more predefined advertisement categories; and
maintain, for each user, an advertisement preference file that specifies the predefined advertisement categories associated with each monitored query entered by the user, thus generating a list of user-preferred advertisement categories.

66. The processor and memory of claim 65 wherein said processor and memory are incorporated into a personal computer.

67. The processor and memory of claim 65 wherein said processor and memory are incorporated into a network server.

68. The processor and memory of claim 65 wherein said processor and memory are incorporated into a single board computer.
